(19) United States
(12) Patent Application Publication
(10) Pub. No.: US 2013/0097042 A1
(43) Pub. Date: Apr. 18, 2013

(54) COMMERCIAL TRANSACTION SYSTEM USING ONLINE INFORMATION MATCHING AND SERVICE PROVIDING METHOD THEREOF

(71) Applicant: Chang Keun Lee, Seoul (KR)

(72) Inventor: Chang Keun Lee, Seoul (KR)

(21) Appl. No.: 13/577,676

(22) PCT Filed: Feb. 8, 2011
(86) PCT No.: PCT/KR2011/000802

§ 371 Date: Dec. 28, 2012

(30) Foreign Application Priority Data
Feb. 8, 2010 (KR) 1020100011675

(51) Int. Cl. G06Q 30/06

(52) U.S. Cl. CPC G06Q 30/0601
USPC 705/26.1

(57) ABSTRACT

The invention is about an electronic commerce system using on-line information matching and its services meant to offer real-time matching service between buyers and sellers, upon request from the buyer, User's Server, by granting the seller, Merchandiser's Server a signal code to respond to buyer's queries by selectively providing the queried information to the said User's Server by way of a bi-directional communication means to conclude the commercial relationship therebetween.

In establishment of the foresaid the invention systemizes an Operation Server, equipped with ‘Querier’, ‘Merchandiser Registerer’, ‘Integrated Information Manager’, and ‘Matching Program Operator’, ‘User's Server’, querying information to the said Operation Server, and ‘Merchandiser's Server’, offering information as queried so.

The said system processes, in order, ‘Membership Phase’, ‘Program Installation Phase’, ‘Merchandiser Registration Phase’, ‘Call-signal Distribution Phase’, ‘Querying Phase’, ‘Code Classification Phase’, ‘Information Collation Phase’, and ‘Information Accessing Phase’.

### TECHNICAL FIELD

The invention is about an electronic commerce system using on-line information matching and its services, to be accurate about furnishment of Merchandiser's Server to offer real-time matching service between buyers and sellers, granting each server a signal code to respond to queries from User's Server, selectively provide the queried information to the said User's Server as set (i.e., 10 pieces of information within 5 minutes from query), and conclude a real-time match between the said buyers and sellers for the purpose of on-line transaction and by way of an instant chatting.

### BACKGROUND ART

Websites (homepages) are where information is offered on-line and commercial transaction is made as designed to provide a wide range of information (including political, economic, social, cultural information, etc.) for a multitude of users who pay a visit to the websites to acquire the information, products or services as needed without time and spatial constraints.

Such users must access what we call ‘portal site’ or ‘search engine’ or take to directly entering URL (uniform resource locator) in their effort to refer to the desired information and shop around to make a purchase.

Such information can be said as an output of the user's conduct searching or referring to the information. Users may further click on to dig deep into what they found out, identical to or relevant to their query.

By way of the said ‘web-surfing’ procedure users get to confirm the appropriateness of the referred information. This, however, must require much time and ‘firsthand’ effort of them.

Suppose there is a user trying to book a hotel in the city of ‘Kyeongju’, taking to the Internet to type in and search ‘Kyeongju’, or ‘Hotel in Kyeongju’, and referring to tens of thousands of the queried information.

This must follow the user's firsthand effort to one-by-one click on the search result to access each and to further check the availability and price of a room. In addition to such a ‘collation and comparison of information’, this also leaves logging-in to the site or phone-contacting or e-mailing the hotel as the user's duty to conclude a reservation.

From the point of view of a merchandiser, here a hotel, by no means may the merchandiser promote itself and have the user, shopping around, take the purchasing decision.

Despite some merchandisers' effort to pay an amount to take priority at the portal site to make themselves appear on top of the search result, this may never be the ultimate solution for everyone's sake as a slew of competitors willing to pay more to put themselves on top.

Overall, the current world with the saturated information makes the existing portal sites and size of a monitor display so marginalized that the queried information is never be exposed at a look.

Even acquired with a bunch of efforts, the information is not necessarily a ‘desired’ one or, from time to time, less accessible given the intricacy of URL structure. Not to mention the inability to provide an alternative in case, for the example of hotel reservation, fully booked out.

The foresaid problem may go for any other type of on-line promotion of the goods and services which may be led, if successful, to the sales off-line.

For instance, a user willing to purchase a ‘red cap’ may follow the suit of what is required for on-line hotel reservation by roaming around the Internet for the availability of the goods.

This may lead to a commercial tragedy where the sought-after sellers cannot sell and desperate buyers cannot buy only because of the non-appearance against the query.

This brings the necessity to ‘real-time-match’ such buyers and sellers, getting out of the convention where the queried information is listed and users exhaustively refer to each result of search.

In the deluge of information users are mostly stressed out of the coercive reference to the Internet to purchase a ‘red cap’ and at the same time living in the world of irony where sellers ended up having their goods and services unsold.

### DISCLOSURE OF INVENTION

### Technical Problem

The invention is thus to suggest a solution for the latent problem on information acquisition and electronic commerce. To be specific the invention is to register the individual, corporate, and institutional sellers, service providers, and knowledge bearers to Merchandiser's Server, grant each a unique signal code by their items of business, respond real-time toward the user's query, and provide the User's Server with the queried information as set (query-back time limit/queries limit/etc.) devoid of the unnecessary process of search. The invention is also to provide a bi-directional means to communicate, in the form of ‘Instant Chatting’ upon which the commercial interaction, such as but not limited to goods and services purchase and knowledge provision, is based.

By means of such a real-time provision of information and commercial interaction the invention is to offer what it calls ‘Real-time Information Matching Service’ as a brand-new revenue model which may help users refer to the desired information in a prompt and accurate manner and purchase. This may also come lucrative to sellers by being able to contact a broader scope of users.

### Solution to Problem

The invention, Electronic Commerce System using On-line Information Matching and the Services, comprises:

1. ‘Operation Server’, equipped with ‘Querier’, ‘Merchandiser Registerer’, ‘Integrated Information Manager’, and ‘Matching Program Operator’,

2. ‘User's Server’, querying information to the said Operation Server, and

3. ‘Merchandiser's Server’, offering information as queried so.

The said system processes, in order, ‘Membership Phase’, ‘Program Installation Phase’, ‘Merchandiser Registration Phase’, ‘Call-signal Distribution Phase’, ‘Querying Phase’, ‘Code Classification Phase’, ‘Information Collation Phase’, and ‘Information Accessing Phase’.

### Advantageous Effects of Invention

The invention is to register the individual, corporate, and institutional sellers, service providers, and knowledge bearers to Merchandiser's Server, grant each a unique signal code by their items of business, respond real-time toward the user's query, and provide the User's Server with the queried information as set (reaction time limit/queries limit/etc.) devoid of the unnecessary process of search. The invention is also to provide a bi-directional means to communicate, clear and prompt, for a brand-new means of on-line revenue model such as but not limited to goods and services purchase and knowledge provision.

By means of such a real-time provision of information and commercial interaction the invention is to offer what it calls ‘Real-time Information Matching Service’ as a brand-new revenue model which may help users refer to the desired information in a prompt and selective manner and purchase. This may also come lucrative to the lesser-known sellers by being able to contact a broader scope of users.

### BRIEF DESCRIPTION OF THE DRAWINGS

FIG. 1: Structural outline for the electronic commercial system of the invention, using On-line Information Matching

FIG. 2: Schematic diagram for ‘Operation Server’ of the invention

FIG. 3: Schematic diagram for ‘Merchandiser's Server’ of the invention

FIG. 4: Schematic diagram for ‘User's Server’ of the invention

FIG. 5: Conceptual diagram for the service of On-line Information Matching of the invention

FIG. 6: Sequence chart for the service of On-line Information Matching of the invention

FIG. 7: Flow chart for the service of On-line Information Matching of the invention

### BEST MODE FOR CARRYING OUT THE INVENTION

The following is the executional details of the invention, Electronic Commerce System using On-line Information Matching and the Services, based upon what Figures set forth.

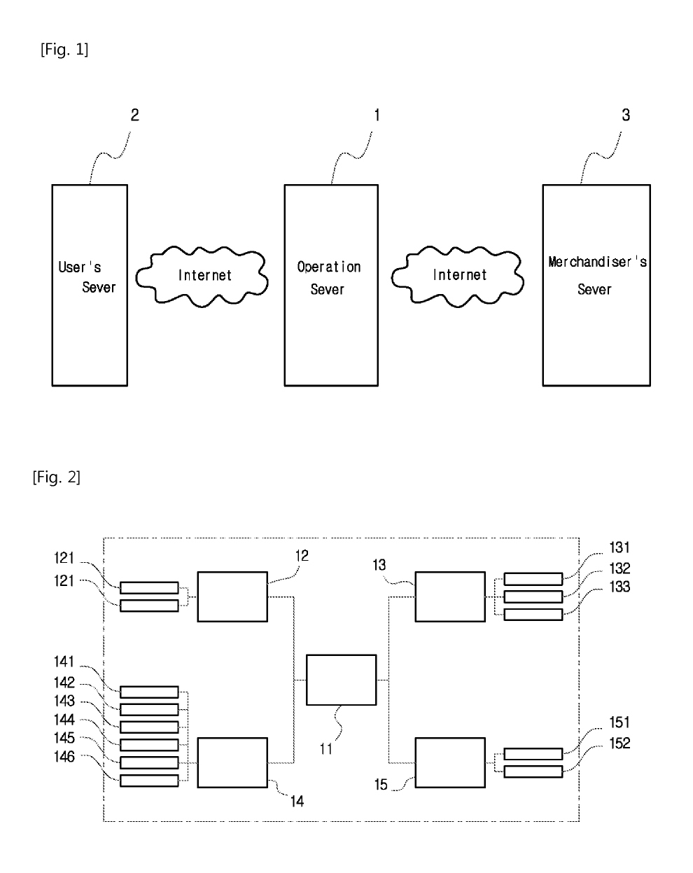

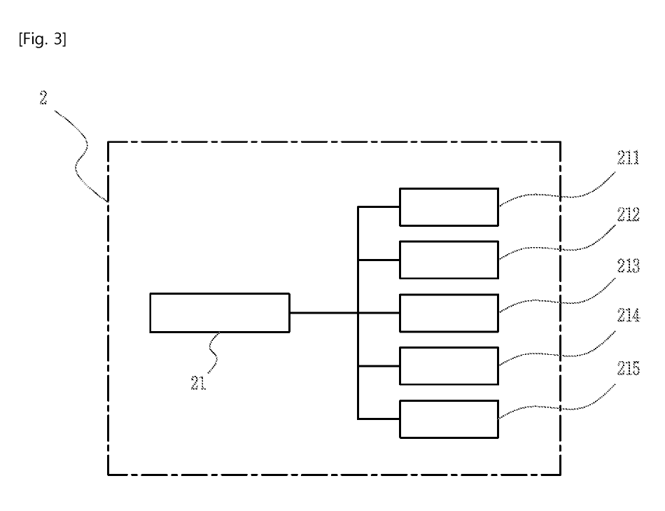

FIGS. 1 to 4, each detailing ‘Structural outline for the electronic commercial system of the invention, using On-line Information Matching’, ‘Schematic diagram for ‘Operation Server’ of the invention’, ‘Schematic diagram for ‘Merchandiser's Server’ of the invention’, and ‘Schematic diagram for ‘User's Server’ of the invention’, comprise Operation Server (1), User's Server (2), and Merchandiser's Server (3). The said Operation Server, on which the invention is pivoting, is for the prompt response upon the queries by the unspecified number of User's Servers and preferably furnished with Information Auto-processor (11) and, as what FIG. 2 sets forth, Querier (12), Merchandiser Registerer (13), Integrated Information Manager (14), and Matching Program Operator (15).

The said Information Auto-processor (11) of Operation Server (1) is to categorize, by the items of business, the User's Server (2) and Merchandiser's Server (3) detailed hereunder and offer a real-time on-line matching thereamong. Such an Information Auto-processor (11) exists as a discrete server for data transmissions in the form of text message, e-mail, web browser menu composition, voice, video, still-image, etc.

The said Querier (12) of Operation Server (1) is to register the unspecified User's Servers, upon request, to grant access to the information matching services for the real-time on-line goods and services information and, as what FIG. 2 sets forth, comprising User Registration Mode (121) and User Membership Database (122).

The said Merchandiser Registerer (13) of Operation Server (1) is to register the Merchandiser's Servers, upon request, to grant a right to provide information to the said User's Servers (2) as to the real-time on-line goods and services information and, as what FIG. 2 sets forth, comprising Merchandiser Registration Mode (131), Coding Mode (132) and Merchandiser Membership Database (133).

The said Integrated Information Manager (14) of Operation Server (1) is to integrate the data management such as, but not limited to, the analysis of the matching information of the goods and services requested by User's Server (2), categorization of the real-time information provided by Merchandiser's Server (3), and transmission of the categorized information back to the said User's Server (2) and, as what FIG. 2 sets forth, comprising Item Classification Mode (141), Signal Data Extraction Mode (142), Call-signal Transmission Mode (143), Matching Information Collation Mode (144), Matching Information Categorization Mode (145), and Categorized Information Transmission Mode (146).

The said Matching Program Operator (15) of Operation Server (1) is to transmit Information Preparation Program (21) to User's Server (2), as necessary for use of Electronic Commerce Service of the invention, and offer the bi-directional communication means between the said User's Server (2) and Merchandiser's Server (3), and comprising Program Transmission Mode (151) and Instant Chatting Execution Mode (152).

Meanwhile, User's Server (2) herein refers to any of the user's servers in need of and requesting the desired goods and services and corresponding matching information and is thus preferable to be installed with Information Preparation Program (21).

The said Information Preparation Program (21) is a web-based introductory program for use of Electronic Commerce Service of the invention and comprising Requested Information Input Mode (211), Matching Condition Setting Mode (212), Matched Information Reception Mode (213), Appraisal Mode (214), and Matching Information Selection Mode (215). The said Information Input Mode (211) in particular comprises an icon-based program featuring a character of the Ginie.

Merchandiser's Server (3) herein refers to any of the merchandiser's server, such as but not limited to individual, corporate, and institutional sellers, service providers, and knowledge bearers, wanting to provide the real-time information to attract the requesting User's Server (2) and is thus preferable to be equipped with, as what FIG. 4 sets forth, Call Receptor (31), Information Compiler and Sender (32) to comprise a discrete web-based program.

The invention as said is thus to realize, by way of its system, a brand-new and differentiated Information Matching Electronic Commerce Service, and is processing the following executional detail.

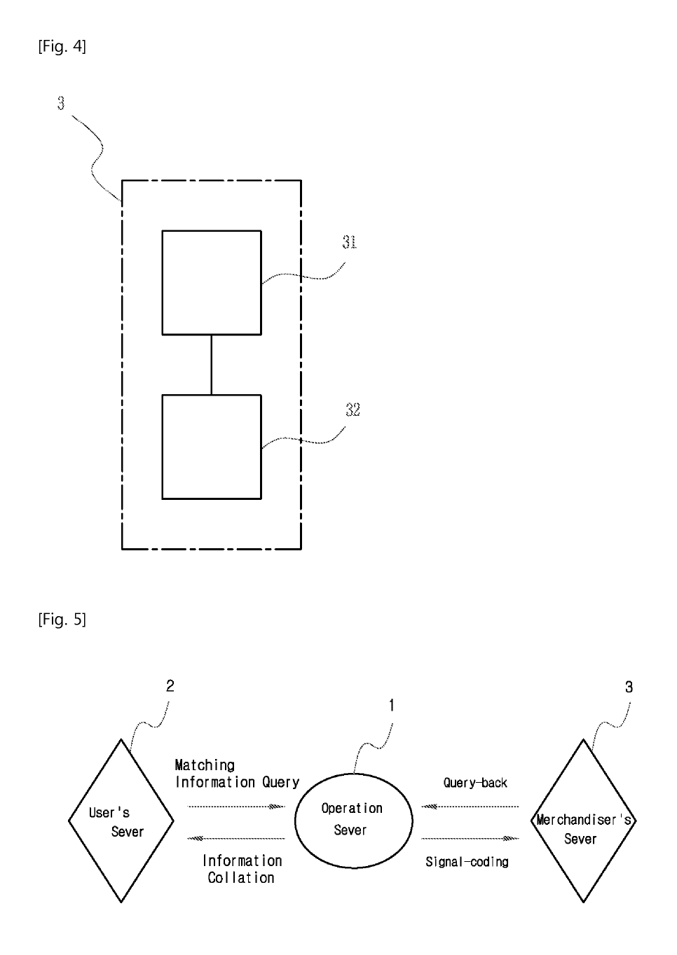

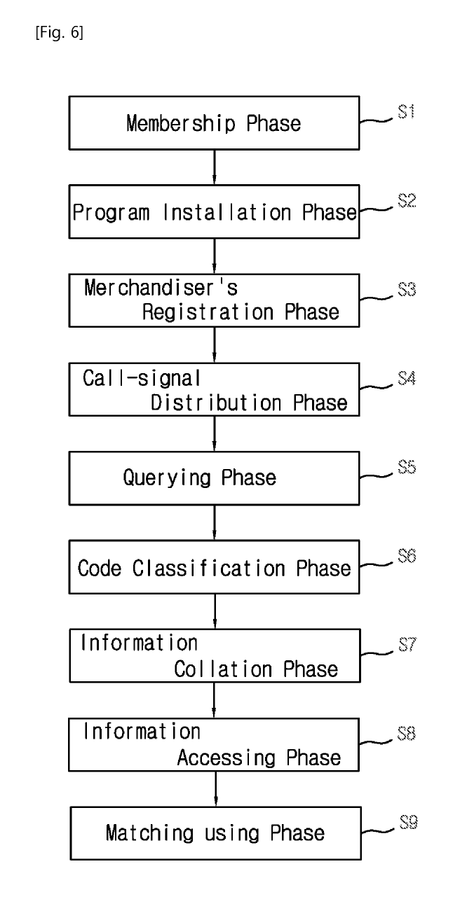

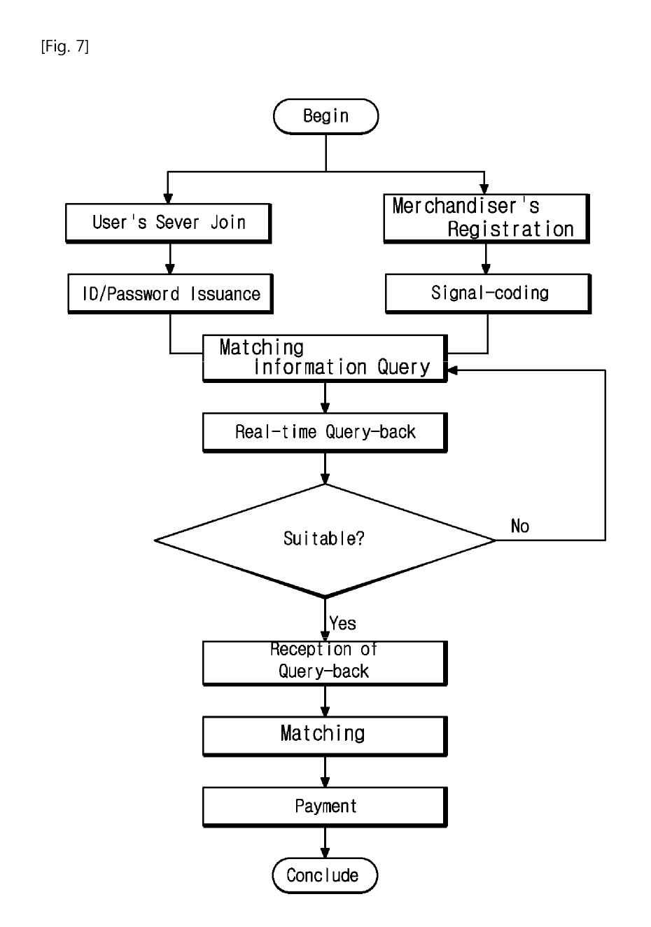

FIGS. 5 to 7, each detailing ‘Conceptual diagram for the service of On-line Information Matching of the invention’, ‘Sequence chart for the service of On-line Information Matching of the invention’, and ‘Flow chart for the service of On-line Information Matching of the invention’, process Membership Phase (S1), Program Installation Phase (S2), Merchandiser Registration Phase (S3), Call-signal Distribution Phase (S4), Querying Phase (S5), Merchandiser Classification Phase (S6), Information Collation Phase (S7), Information Provision Phase (S8), and Information Implementation Phase (S9).

The said Membership Phase (S1) is to link the unspecified number of User's Servers (2), desiring to use Information Matching Electronic Commerce Service, to Operation Server (1) by way of Information Auto-processor (11), be provided with the identification data of the said User's Servers (2) necessary for use of the said Service by way of User Registration Mode (121) of Querier (12), issue an ID and password to the concerned User's Servers (2) to conclude registration to Information Matching Electronic Commerce Service, and maintain a database thereof in User Membership Database (122) in Querier (12).

Meanwhile, the said identification data comprises a series of mandatory information such as name, address, Social Security No., phone contact, and e-mail contact. The said membership process is concluded by paying a pre-determined amount of membership fee or else by watching mandatory advertisement to be fee-exempted.

The said Program Installation Phase (S2) is to help the registered User's Server (2) query and receive the corresponding information by way of Information Preparation Program (21) transmitted by way of Matching Program Operator (15) to the said User's Server (2) for installation thereof.

The said Merchandiser Registration Phase (S3) is to register the individual, corporate, and institutional sellers, service providers, and knowledge bearers wishing to offer their real-time information to Merchandiser's Server and is established by linking Merchandiser's Server (3) to Operation Server (1) by way of Information Auto-processor (11), receiving the identification information of, for the department store, restaurant, hotel, law firm, clothing outlet, and any other commercial goods and services providers, the business items, Business Registration No., location, phone contact, website URL, and e-mail contact or, for the research institute, public institution, museum, library, scholarly research institute, and any other knowledge-bearing institutions or individuals, the title of knowledge, affiliation, phone contact, and e-mail contact in exchange for the information provision by way of Merchandiser Registration Mode (131) of Merchandiser Registerer (13) and maintaining such data at Merchandiser Membership Database (133) of Merchandiser Registerer (13),

The said Call-signal Distribution Phase (S4) is to categorize the registered Merchandiser's Server (3) into the service provider, goods seller, and knowledge bearer and to detail out into the category of the business items such as, but not limited to, patent consulting, marriage information, translation, shoes sales, computer sales, car sales, hotel reservation, Chinese restaurant (food delivery) or, for the said knowledge bearer, into the category of, but not limited to, diet, dating, longevity, healthcare, cultural property introduction, and learning method and grant a query-responding Call-signal code for each item of business by way of Coding Mode (132) of Merchandiser Registerer (13).

Such a Call-signal code is to be made up indicating the service type, business item, location of business, and serial number to indicate, say, a patent consulting office in Seoul “S(service)-S1(business location of Seoul)-P(business item)-001(serial number)”, a shoes outlet in Busan “G(goods)-B1(business location of Busan)-S(business item)-001(serial number)”, or a dietary research lab in Kyeongju (knowledge bearer of diet) “I(information)-K3(business location of Kyeongju-D(business item)-001(serial number)”. The said serial number is to further classify a slew of different businesses involved in the same business category. The foresaid is an example may vary if deemed better categorizing.

Any of Merchandiser's Servers (3) is to make a payment in exchange for being granted the said signal code at the flat rate, usage-based rate, and any other rates in accordance with the commercial custom.

The said Querying Phase (S5) is to query the desired matching information to Operation Server (1) by way of the said Information Preparation Program (21) installed at User's Server (2) by detailing out the query via Information Input Mode (211) like “Ten A4 sheets to be rendered into English within 2 days at a reasonable rate”, setting the query-back time limit (10-min), queries limit (10 queries), means of reception (on-screen display, e-mail, SMS, instant chatting, etc.), and any other query conditions via Matching Condition Setting Mode (212), and transmitting the query back to the said Operation Server (1).

In particular, the said Information Input Mode (211) of Information Preparation Program (21) installed at User's Server (2) features an icon of a character of the Ginie popping up a input window (“How may I help you?”) to make available the user to query.

The said Merchandiser Classification Phase (S6) is to classify, extract, and process the queried information of, say, “Ten A4 sheets to be rendered into English within 2 days at a reasonable rate” from User's Server (2), assigning the said information to Classification Mode (141) of Integrated Information Manager (14) to classify the concerned query into “Translation”, assigning once again the query to Signal Data Extraction Mode (142) of Integrated Information Manager (14) to single out the corresponding Merchandiser's Servers (3) coded as “Translation service provider”.

The said Information Collation Phase (S7) is for User's Server (2) to transmit the matching information queried out to Operation Server (1) once again to Merchandiser's Server (3) for real-time query-back.

In particular, whilst the foresaid proceeds, Call Receptor (31) of Merchandiser's Server (3) is to pop up “Here comes a message” or “Translator request detected” for the said merchandisers scramble for query-back of the request, being collated by Operation Server (1).

To proceed the foresaid the queried information by User's Server (2) is to be sent out to Call Receptor (31) of the concerned Merchandiser's Servers, as coded matching the query condition (query-back time limit, queries limit, by way of Call-signal Transmission Mode(143) of Integrated Information Manager (14), request the query-back, and for the concerned merchandiser's servers to query back by way of Information Compiler and Sender (32), upon the request of, say, “Ten A4 sheets to be rendered into English within 2 days at a reasonable rate” by responding back “2-day translation available by professional translator at the rate of KRW 30,000 a sheet” with provision of the subsidiary information (translator identification, work experience, affiliation, etc.) to Operation Server (1) to be kept and maintained at Matching Information Collation Mode (144) of Integrated Information Manager (14).

The said Information Provision Phase (S8) is to assign the query-back from Merchandiser's Server (3) to Information Categorization Mode (145) of Integrated Information Manager (14), verify the said query-back based upon the user's initial query, and to send out, real-time, the verified information to Information Reception Mode (213) of User's Server (2) by way of Categorized Information Transmission Mode (146) of Integrated Information Manager (14).

For any massive transmission of the said verified information by plural Merchandiser's Servers (3), such may be controlled by selectively receiving the information in order of query-back, credibility, etc. or setting time limit to reject the belated information by sending a message of rejection.

Such an information query-back is not deemed limited by way of Information Reception Mode (213) of User's Server (2) but, as set by the concerned user, e-mail, SMS, or Instant Chatting Execution Mode (152) of Operation Server (1) all of which are falling into the category of the invention.

In addition, in any case when User's Server (2) elects to receive the query-back from Merchandiser's Server (3) by means of the instant chatting program, Operation Server (1) is to execute Chatting Execution Mode (152) on the web to selectively match one-to-one or several-for-one, according to the user-set condition (query-back time limit/queries limit/etc.) to give an opportunity for and help User's Server (2) and Merchandiser's Server (3) to transact goods, services, and knowledge.

As for a user's server querying for a “3,000 cc-caliber vehicle” on condition of “10 query-backs in 5-min”, Operation Server (1) is to send out the user's query to the concerned Merchandiser's Server (3) of the vehicle selling companies or individuals, coded so, to let them access the user's instant chatting room to facilitate the transaction.

Upon occurrence of such a transaction Merchandiser's Server (3) may have a chance to promote to set it apart from the competitors by means of, but not limited to offering vouchers.

In any case when User's Server (2) is inactive in Chatting Execution Mode (152) the invention is to make available the notification by way of, but not limited to, mobile handset, etc. in the form of text or voice all of which are falling into the category of the invention.

Lastly, the said Information Implementation Phase (S9) is to receive the information from Operation Server (1) by way of Information Reception Mode (213), e-mail, or SMS of User's Server (2) or Instant Chatting Execution Mode (152) of Operation Server (1), confirm thereof, and conclude, implement, or purchase the goods, services, or knowledge deemed best fitted.

Upon such an implementation User's Server (2) is to evaluate the query-back in Appraisal Mode (214) of Information Preparation Program (21) by grading in a numerical or graphical means in order of the suitability or satisfaction, send the said evaluation back to Operation Server (1) to re-calibrate the credibility and contribution level by marking in different colors of blue (most admired), yellow (promptest responder), or red (most matched and lucrative) for user's convenience to tell good and bad.

Such a User's Server (2) may single out, amongst the list of Merchandiser's Servers (3) queried back the most suitable one in Matching Information Selection Mode (215) of Information Preparation Program (21), send the choice back to Operation Server (1) to be charged (by way of payment pop-up), and thus conclude the on-line matching for transaction.

The said process of Electronic Commerce System using On-line Information Matching and the Services is deemed not limited to the information matching service for provision of goods, services, and know-how (knowledge) to User's Server (2) but shall apply to the other way round where User's Server (2) merchandises its own goods and services.

For instance, as for a User's Server (2) merchandising a second-hand laptop, this may send out a message, by way of Information Input Mode (211), by saying “Sens 520, been a year from purchase in good condition. Priced KRW 500,000” on condition of “10 queries in 10-min from the region of Seoul by instant chatting” to plural Merchandiser's Servers (3), coded as ‘second-hand home appliance trader’, match the corresponding Merchandiser's Servers (3) real-time by instant chatting for User's Server (2) to single out the best fitted to whom it may sell the goods promptly at a desired price.

Also, as for a User's Server (2) wanting to take on a part-timer by saying “Needing part-timer for convenience store in Gangnam, Seoul”, this may also be sent out to plural Merchandiser's Servers (3), coded as ‘part-timer agency’, to match the corresponding Merchandiser's Servers (3) and User's Server (2) real-time.

In turn, the invention, Electronic Commerce System using On-line Information Matching and the Services, is to allow the coded service providers or knowledge bearers to be responding real-time to the user's query, devoid of the users' inconvenience of information retrieval listing out the candidate websites for the desired goods and services.

1. Operation Server furnished with Information Auto-processor as part thereof and further equipped with Querier, Merchandiser Registerer, Integrated Information Manager, and Matching Program Operator;
user's Server installed with Information Preparation Program accessing the said Operation Server to query; and
merchandiser's Server equipped with Call Receptor, accessing the said Operation Server to be coded and react real-time upon request from the said User's Server, and Information Compiler and Sender.

2. In regards to claim 1,
merchandiser Registerer comprising Merchandiser Registration Mode, Coding Mode, and Merchandiser Membership Database.

3. In regards to claim 1,
integrated Information Manager comprising Item Classification Mode, Signal Data Extraction Mode, Call-signal Transmission Mode, Matching Information Collation Mode, Matching Information Categorization Mode, and Categorized Information Transmission Mode.

4. In regards to claim 1,
matching Program Operator further equipped with Program Transmission Mode and Instant Chatting Execution Mode.

5. In regards to claim 1,
information Preparation Program, installed at User's Server and comprising Requested Information Input Mode, Matching Condition Setting Mode, Matched Information Reception Mode, Appraisal Mode, and Matching Information Selection Mode.

6. Membership Phase linking the unspecified number of User's Servers, desiring to use Information Matching Electronic Commerce Service, to Operation Server by way of User Registration Mode of Querier in conclusion of registration;
program Installation Phase helping the registered User's Server query and receive the corresponding information by way of Information Preparation Program transmitted by way of Matching Program Operator to the said User's Server for installation thereof;
merchandiser Registration Phase registering the querying entities of Merchandiser's Servers by linking them to Operation Server by way of Merchandiser Registration Mode of Merchandiser Registerer;
call-signal Distribution Phase categorizing the said Merchandiser's Servers into the service provider, goods seller, and knowledge bearer and to detail out into the category of the business items by way of Coding Mode;
querying Phase querying the desired matching information to Operation Server by way of the said Information Preparation Program installed at User's Server by detailing out the query via Information Input Mode and any other query conditions via Matching Condition Setting Mode, and transmitting the query back to the said Operation Server;
merchandiser Classification Phase classifying and extracting the queried information from User's Server, assigning the said information to Classification Mode and, once again, to Signal Data Extraction Mode to single out the corresponding Merchandiser's Servers;
information Collation Phase for User's Server to transmit the matching information queried out to Operation Server once again to Merchandiser's Server for real-time query-back by way of Call-signal Transmission Mode and for keeping and maintaining such a query-back at Matching Information Collation Mode
information Provision Phase verifying the said query-back by way of Information Categorization Mode and sending out the verified information by way of Categorized Information Transmission Mode; and
information Implementation Phase receiving the information, as reacted by Information Preparation Program of User's Server, by way of Information Reception Mode for the purpose of implementation thereof.

7. In regards to claim 6,
call-signal code made up indicating the service type, business item, location of business, and serial number duly granted to Merchandiser's Server.

8. In regards to claim 6,
querying Phase querying the desired matching information by setting the query-back time limit, queries limit, means of reception, and any other query conditions via Matching Condition Setting Mode.

9. In regards to claim 6,
information Provision Phase querying back to User's Server by way of e-mail, SMS, or Instant Chatting Execution Mode and, in any case when User's Server elects the said Instant Chatting Execution Mode, Operation Server executing Chatting Execution Mode on the web to selectively match one-to-one or several-for-one in facilitation of real-time communication for transaction and bargaining.

10. In regards to claim 5,
user's Server evaluating the query-back in Appraisal Mode and singling out the most suitable Merchandiser's Server in Matching Information Selection Mode to conclude the on-line matching for transaction.
